(19) United States
(12) Patent Application Publication
(10) Pub. No.: US 2009/0020619 A1
(43) Pub. Date: Jan. 22, 2009

(54) Electrical Auxiliary Heater

(75) Inventors: Franz Bohlender, Kandel (DE); Michael Niederer, Kapellen Drusweiler (DE)

Correspondence Address: BOYLE FREDRICKSON S.C., 840 North Plankinton Avenue, MILWAUKEE, WI, 53203, US

(73) Assignee: CATEM GMBH & CO. KG, Herxheim bei Landau (DE)

(21) Appl. No.: 12/175,134

(22) Filed: Jul. 17, 2008

(30) Foreign Application Priority Data
Jul. 18, 2007 (EP) 07014115.5
Jan. 18, 2008 (EP) 08000980.6

(51) Int. Cl. B60H 1/22

(52) U.S. Cl. 237/12.3 C

(57) ABSTRACT

An auxiliary heater for a motor vehicle has a layer structure comprising a heat generating element with at least one PTC heating element and printed conductors contacting the PTC heating element on both sides for powering the PTC heating element and at least one heat dissipating element, connected for thermal conduction with the heat generating element. A housing accommodates the layer structure as well as contact lugs for the connection of the auxiliary heater to a power source. For providing the best possible and simplist connection to a power source via a plug element, and with regard to the economical manufacture of the auxiliary heater, the contact lugs are formed by stamped sheet metal pieces which are electrically connected to selected printed conductors.

### BACKGROUND OF THE INVENTION

1. Field of the Invention

The present invention relates to an electrical auxiliary heater with the pre-characterising features of Claim 1.

2. Description of the Related Art

An auxiliary heater of this nature is for example known from EP 0 350 528 or from EP 1 564 503. Generally, the printed conductors for powering the PTC heating elements are formed by sheet metal bands of which selected sheet metal bands are brought out of the side of the housing, which is normally formed as a flat frame with, essentially, the thickness of the layer structure. These sheet metal bands, brought out at the side and over the circumferential edge of the frame, here form contact lugs for the connection of the electrical auxiliary heater to the power supply. The connection can also occur with the intervening positioning of an open or closed-loop control element plugged onto the contact lugs.

With electrical auxiliary heaters of this type, in particular in a motor vehicle for the heating of the passenger compartment, relatively high currents are used because heating powers of between 2,000 and 3,000 watts must be output by the electrical auxiliary heater and the vehicle electrical system is normally operated at 12 volts. Therefore, the surface of the contact lug used for contacting the connector element must ensure a good transfer of electrical current. For economical reasons however the printed conductors should be cut off from an endless band and inserted in the housing preferably without further processing and irrespective of whether the corresponding printed conductors form contact lugs on the outside or terminate inside the housing.

### OBJECT OF THE INVENTION

The object of the present invention is to provide an electrical auxiliary heater, which fulfils on one hand the above mentioned, partially conflicting requirements of economical manufacture and on the other hand a good and reliable plug connection to the electrical auxiliary heater.

This object is solved according to the present invention by an electrical auxiliary heater having the features of Claim 1. The electrical auxiliary heater according to the invention differs from the prior state of the art in that the contact lugs are formed by stamped sheet metal pieces which are electrically connected to selected printed conductors. In other words the sheet metal band, which previously in the state of the art was brought out directly via the housing at the side to form contact lugs, preferably terminates within the housing, whereas the contact lugs protruding beyond the housing are formed from a separate component, namely a stamped sheet metal piece which is electrically connected to the printed conductors, generally within the housing. Here, different material thicknesses can be selected for the printed conductors on one hand and the stamped sheet metal piece on the other in order to facilitate the simplest possible plug connection of a mating plug to the contact lugs without having to use relatively thick sheet metal bands or similar parts for the printed conductors for powering the PTC heating elements.

The stamped sheet metal piece and the selected printed conductor can in principle be joined together according to various techniques. Thus, it is possible to join both components by welding or soldering. An adhesive joint is also conceivable.

Preferably, the sheet metal piece and the printed conductor, which is especially preferably formed in the shape of a sheet metal band, are positioned parallel to one another and have an overlapping longitudinal part, where the stamped sheet metal piece lies parallel to the assigned printed conductor and contacts it. The overlapping longitudinal part should here be selected such that a reliable contact to the adjacent components is achieved. According to another preferred embodiment of the present invention, the sheet metal piece has at least one, preferably many protrusions, which are particularly preferably formed by means of stamping the sheet metal piece. Alternatively, appropriate protrusions can also be provided on the sheet metal band forming the printed conductor. Just as well, appropriate protrusions can be provided both on the sheet metal band and also on the sheet metal piece. The protrusions are used for the specific electrical contacting of the two components in the overlapping longitudinal region. The electrical contacting between the sheet metal band and contact lug should take place solely via these protrusions. In this way it is ensured that the current transfer from the contact lug into the printed conductor occurs in a defined manner.

With regard to the most economical manufacture, according to a preferred further development of the present invention, it is suggested that the printed conductor is connected to the contact lug via a spring element. The spring element establishes a positive connection of the two components, preferably, where they have overlapping longitudinal parts, by contact pressure between the two components. Here, according to a further preferred embodiment of the present invention, the spring element can also be used to hold the sheet metal piece on the housing. This holding action can be directly realised by the interaction of the spring element and the housing or housing parts. The spring element can for example clamp the sheet metal piece—with an intervening position of the corresponding walls of the housing—thus fixing it with respect to the housing. Alternatively, the spring element can also be provided in a housing formed specifically for the accommodation of the spring element. This housing is designated in the following as the spring receptacle and is formed in such a way that it holds the spring element with only slight play. The spring receptacle accordingly forms limit stops, against which the spring abuts during a possible relative movement of the contact lug inserted into the housing in order to limit this relative movement.

To simplify the assembly of the electrical auxiliary heater the housing comprises a housing lower part, which is essentially dish-shaped and, at least partially, holds the layer structure circumferentially, so that the layer structure can be positioned in the specified manner by placement in the housing lower part. Furthermore, the housing lower part is formed such that with interaction with the contours of the spring element in the installation position of the spring element it essentially prevents movement in the longitudinal direction of the layers of the layer structure. Through the interaction of the housing lower part and spring element, the position of the spring element is accordingly essentially specified in the longitudinal direction of the printed conductor. In particular the previously mentioned spring receptacle is formed by the housing lower part.

According to a further preferred embodiment of the invention the spring element is formed in the shape of a spring clamp, the oppositely situated spring limbs of which clamp the printed conductor and the sheet metal piece between them in the installation position of the spring element. Preferably, for each contact lug a corresponding spring clamp is provided, the spring force of which solely produces the contacting of the printed conductor and sheet metal piece.

To fix the spring clamp clamping the printed conductor and the sheet metal piece, according to a further preferred embodiment of the present invention it is suggested that on both sides of the sheet metal piece and/or of the printed conductor, protrusions are formed and that at least one of the spring limbs contacts the sheet metal piece or the printed conductor between two protrusions. The protrusions, which can preferably be provided in oppositely situated parallel rows, form accordingly elevations between which a contact base of the spring limb on the sheet metal piece or the printed conductor is formed, preventing the spring clamp from slipping in a direction essentially at right angles to the longitudinal extension of the printed conductor. Here, it is assumed that the spring clamp preferably forms oppositely situated convex protrusions which contact the sheet metal piece or the printed conductor and pass the protrusions provided on the sheet metal piece and/or printed conductor at a certain distance. In other words the spring limbs with their convex protrusions should reliably contact between the oppositely situated protrusions on the sheet metal piece or printed conductor which are preferably formed by means of stamping.

According to a further preferred embodiment of the present invention, which facilitates a simple preassembly of all single parts of the electrical auxiliary heater, the housing lower part forms the spring receptacle and in fact in such a manner that it opens in the insertion direction of the elements of the layer structure. Within the spring receptacle there is also with this preferred embodiment the overlapping longitudinal part. Preferably, this overlapping longitudinal part is essentially restricted to the extension of the spring receptacle.

To position the selected printed conductor or the sheet metal piece before completing the assembly of all components of the electrical auxiliary heater, in particular before fitting the spring clamp, it is preferable to provide the spring receptacles with slots opening in the longitudinal direction of the layers of the layer structure, which are formed suitably for the accommodation of the sheet metal piece and/or printed conductor. The slots are here preferably dimensioned such that the printed conductor, but in particular the sheet metal piece, is aligned parallel to the planes of the layer structure. Accordingly, a spring clamp pushed in the insertion direction over the printed conductor and sheet metal piece can securely grip both parts and hold them together under tension. For this purpose the spring clamp has at its front region preferably a slightly funnel-shaped insertion opening formed by the two spring limbs.

According to a further preferred embodiment of the present invention, the maximum penetration depth of the sheet metal piece into the housing is restricted by the formation of at least one of the slots. Preferably the slot provided between the spring receptacle and the layer structure here forms a limit stop for the sheet metal piece, which prevents deeper penetration of the sheet metal piece in the direction onto the layer structure, so that even with impact stressing of the contact lugs they are not pushed into the housing where they could cause a short circuit.

According to a further preferred embodiment of the present invention the sheet metal piece forms a plug-on section at its end which protrudes beyond the housing. This is characterised in that it has functional surfaces which are specially adapted to contact surfaces of a plug element which is to be plugged onto the contact lugs. The corresponding functional surface differs in particular from the formation and especially from the dimensioning of the sheet metal piece in the region of the overlapping longitudinal part.

According to a further preferred embodiment of the present invention the sheet metal piece is held on the housing by means of positive locking in the longitudinal direction of the layers of the layer structure. In this respect on one side surface of the sheet metal piece preferably a groove which opens out is provided and in fact between the plug-on section and the overlapping longitudinal part of the sheet metal piece, and a protrusion, which holds the sheet metal piece with slight or even no play and is formed by the housing, engages this groove.

According to a further preferred embodiment the overlapping longitudinal part of the printed conductor preferably terminates before the groove, i.e. the printed conductor does not protrude outwards beyond the groove. Provided that according to a further preferred embodiment the protrusion engaging the groove is part of an edge which encompasses the housing in the circumferential direction, i.e. the protrusion is essentially provided on the outer surface of the housing, it is ensured that the printed conductor is accommodated completely within the housing and only the sheet metal piece protrudes beyond the housing.

Since the housing upper part is normally located on the housing lower part as a type of cover, according to a further preferred embodiment it is suggested also with regard to fixing the spring clamp in the spring receptacle that a ridge joining the two spring limbs of the spring clamp is arranged at approximately the same height with the free end of the spring receptacle formed by the housing lower part. In this way the spring clamp is prevented from being forced out of the spring receptacle. When being forced out, the spring clamp directly abuts the housing upper part, keeping the spring clamp in position.

For the easier assembly of the spring clamps and also with regard to an unambiguous assignment of the housing lower part and the housing upper part, according to a further preferred embodiment of the present invention it is suggested that the spring receptacles are formed to give a number of contact lugs so that they protrude beyond an edge of the housing lower part. This edge is an edge which is normally located parallel to the upper or underside of the housing which has air passing over it and which contacts the lid-shaped housing upper part when the cover is closed. In other words the said edge is delimited on the outside by the edge of the housing running in the circumferential direction around the housing. The edge of the housing running in the circumferential direction extends essentially at right angles to the edge over which the spring receptacles protrude. Therefore, with this embodiment the spring receptacles protrude in the direction of the housing upper part.

Finally, according to a further preferred embodiment of the present invention it is suggested that the upper side of the layer structure is terminated at about the same level as the free end of the spring receptacles, wherein the assembly is simplified and the material expense for producing the housing is kept within reasonable bounds.

Further details and advantages of the invention are given in the following description of an embodiment in conjunction with the drawing. This shows the following:

### BRIEF DESCRIPTION OF THE DRAWINGS

FIG. 1 a perspective side view of an embodiment of the electrical heating device;

FIG. 2 a side view of a housing lower part with an installed heating block from the embodiment illustrated in FIG. 1;

FIG. 3 an enlarged detail from the illustration according to FIG. 2;

FIG. 4 a perspective side view of the embodiment illustrated in FIGS. 1 to 3;

FIG. 5 a perspective side view of the housing upper part of the electrical heating device according to FIG. 1;

FIG. 6 a perspective exploded view of a heat generating element of the electrical heating device according to FIG. 1;

FIG. 7 a sectional illustration along the line VII-VII according to the illustration in FIG. 6 of an assembled heat generating element;

FIG. 8 a perspective front view of a heat generating element with contact lugs connected to it;

FIG. 9 a perspective front view of the still open housing corresponding approximately to FIG. 3;

FIG. 10 the spring element illustrated in FIG. 8;

FIG. 11 an embodiment of a sheet metal piece forming the contact lug in a perspective plan view and

FIG. 12 the embodiment of a sheet metal piece illustrated in FIG. 11 in a front view.

### DETAILED DESCRIPTION OF THE PREFERRED EMBODIMENT

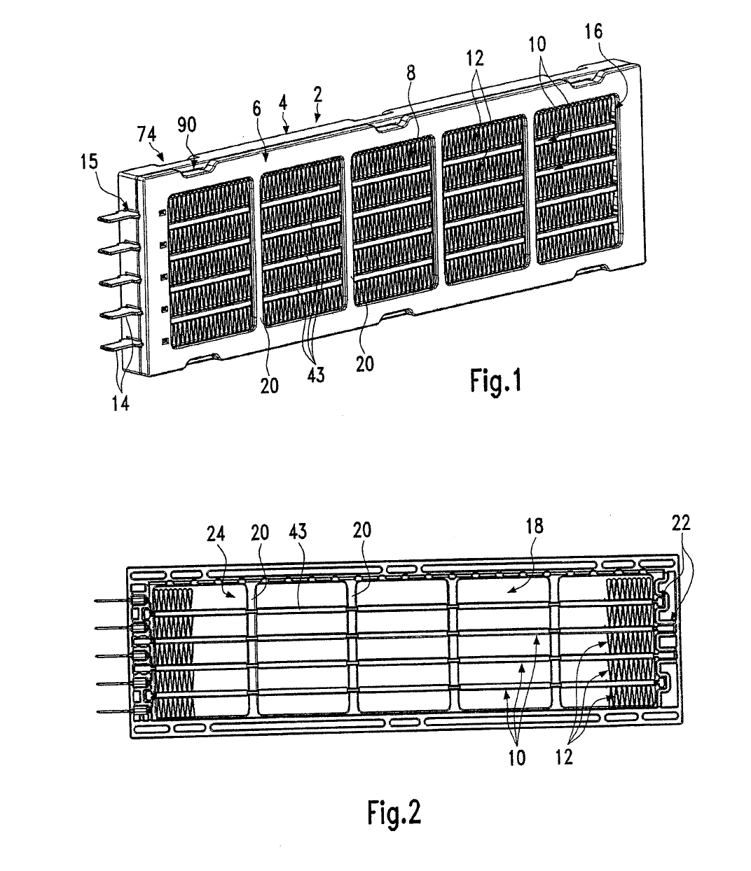

FIG. 1 shows a perspective side view of an embodiment of the electrical heating device with a housing 2, consisting of a housing lower part 4 and a housing upper part 6. Both housing parts 4 and 6 are joined together positively locked and are accommodated in a heating block, which consists of several heat generating elements 10 and heat dissipating elements 12 arranged in layers parallel to one another. The heat dissipating elements 12 are formed as corrugated-rib elements from meander-type bent sheet metal strips.

Five contact lugs 14, arranged one over the other in the transverse direction protrude over a face side of the housing 2. The contact lugs 14 pass through the housing 2 at the cut-out slots 15, each of which accommodate one contact lug 14 and are mainly formed by the housing lower part 4, but are complemented on a face side by the housing upper part 6.

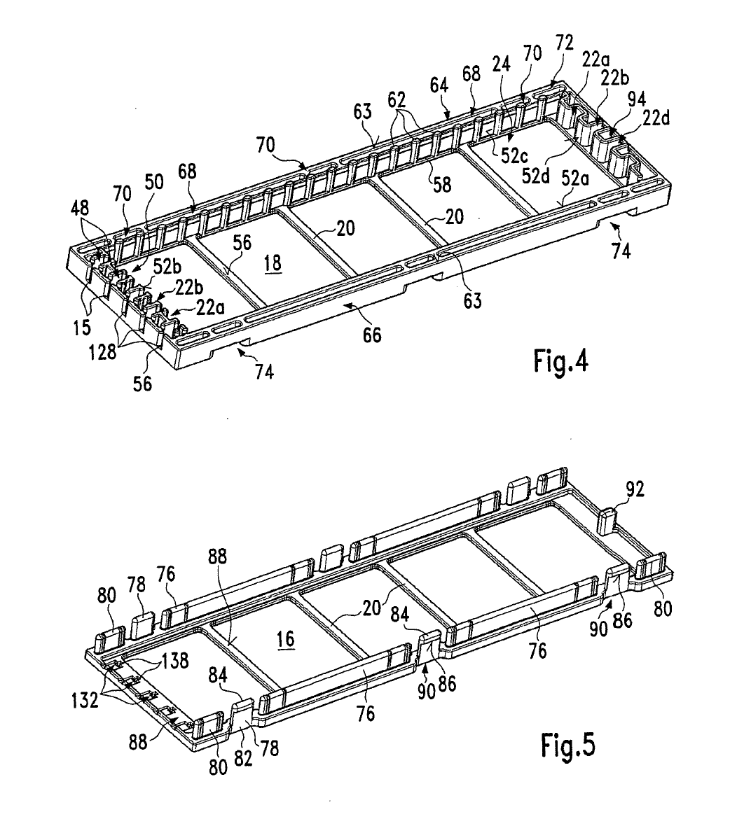

The housing 2 has two oppositely situated frame openings, of which in FIG. 1 only the frame opening 16 formed by the housing upper part 6 can be seen. The frame opening formed by the housing lower part 4 can be seen in FIG. 4 and is identified with the reference numeral 18. The frame openings 16, 18 are each interspersed with struts 20, which extend at right angles to the layers of the heating block 8 and which join together longitudinal spars oppositely situated to one another on the housing lower part 4 and housing upper part 6.

FIG. 2 illustrates details of the heating block 8 and its accommodation in particular in the housing lower part 4 and illustrates the housing lower part 4 in a plan view with the housing upper part removed. The heat dissipating elements 12 are only illustrated incomplete on the respective face side ends of the housing lower part 4. Accordingly, the illustration in FIG. 2 provides a view onto the frame opening 18 formed by the housing lower part 4.

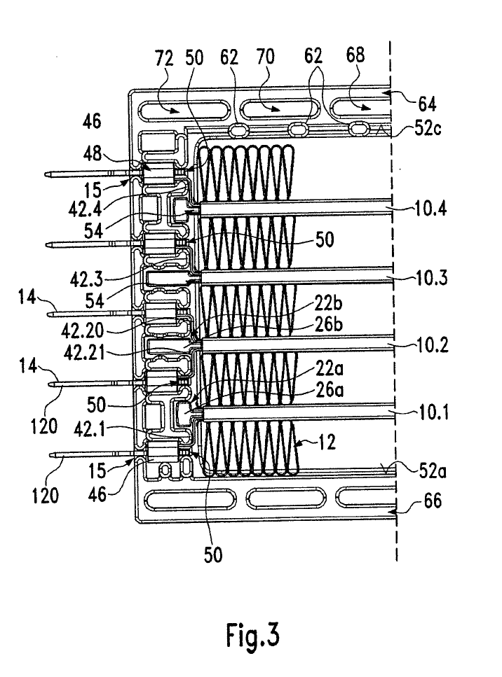

As can be seen, the illustrated embodiment has four heat generating elements 10, which are each insulating on the face side and are accommodated with a certain movement transverse to the layers of the layer structure (heating block 8) in the housing lower part 4. The housing lower part 4 has fitting element receptacles 22 for this, which open to a receptacle 24, which is essentially formed by the housing lower part 4 and accommodates the heating block 8. In the illustrated embodiment on each face side of the housing lower part 4 two different types of fitting element receptacles 22a, 22b are provided (cf. also FIG. 3). Corresponding to the geometry of the fitting element receptacles 22, the heat generating elements 10 have on their face side ends fitting elements 26a, 26b, which each only fit into the appropriate corresponding fitting element receptacle 22a or 22b. Here the corresponding fitting element receptacles 22 are matched to the correspondingly provided fitting elements 26 such that the heat generating elements 10 can move a few tenths of a millimetre transverse to the longitudinal extent of the layers of the heating block 8 in the housing 2. The outer fitting elements 26a are formed as hammer heads and engage appropriately formed fitting element receptacles 22a. In the longitudinal direction of the heat generating elements 10 these are substantially shorter than the second, centrally provided fitting element receptacles 22b. The fitting elements 26b assigned to these longitudinal fitting element receptacles 22b are bar-shaped and less wide than the hammer-head shaped fitting elements 26a. Due to this special embodiment the central heat generating elements 10 do not fit into the outer positions for heat generating elements 10 on the heating block. In a corresponding manner the outer heat generating elements cannot be arranged in the centre of the heating block, i.e. inserted into the housing 2.

Whereas the heat generating elements 10 cannot be inserted at just any random place in housing 2, the heat dissipating corrugated rib elements 12 are produced non-specifically and initially as longitudinal sections of a meander-type bent sheet metal strip and are then cut to length from endless material. Each individual heat dissipating element 12 can be inserted at any position for a heat dissipating element within the heating block 8.

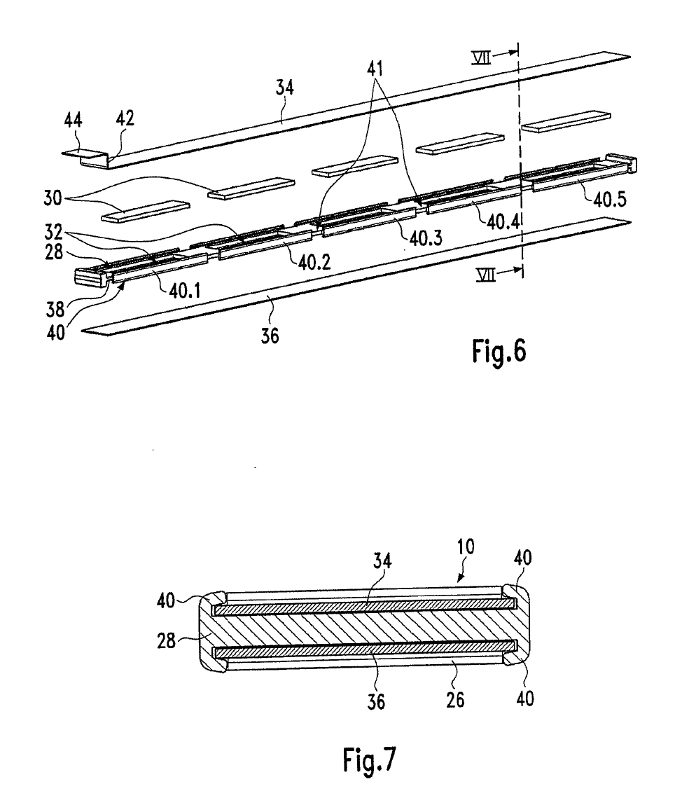

The fitting elements 26 are formed in one piece on a positional frame 28, which can be seen in FIGS. 6 and 7 and are explained in the following in more detail with reference to these figures. The positional frame 28 consists of an insulating material and is used for positioning the PTC heating elements 30. Here, for each individual PTC heating element 30 a receptacle 32 is cut out in the positional frame 28, which circumferentially holds and thus configures this PTC heating element. On both sides of each of the PTC heating elements 30, which are arranged adjacent to one another on one plane, sheet metal bands 34, 36 make contact, which form electrical printed conductors for powering the PTC heating elements 30 and via which the heat produced by the PTC heating elements is passed to the heat dissipating elements 12 by means of thermal conduction. These are located directly on the sheet metal bands 34, 36.

The face side ends of the positional frames 28 are extended by a fitting element ridge 38 beyond the position of the sheet metal bands 34, 36. At the outer ends of the fitting element ridges 38 there are the respective fitting elements 26 of the positional frame 28. As illustrated by the cross-sectional view along the line VII-VII drawn in FIG. 6 (cf. FIG. 7), most of the extent of the positional frame 28 in the breadth direction is taken up by the respective sheet metal bands 34, 36. In the cross-sectional view at the side next to the sheet metal bands 34, 36 the positional frame has retaining ridges 40, which are provided immediately adjacent to the side edge of the sheet metal bands 34, 36 and protrude over the corresponding sheet metal bands 34, 36 on the upper side and overlap them at the outside, preferably touching the printed conductors 34, 36 and making contact to them. In the illustrated embodiment the retaining ridges 40 are formed as a single part in the course of injection moulding, initially as protrusions extending at right angles to the principal extension direction of the positional frame 28. The spacing of oppositely situated protrusions is selected such that the sheet metal band 34 or 36 just fits between these protrusions.

The one-part component manufactured in this way by means of injection moulding is then fitted with the main parts of the heat generating element 10, i.e. the PTC heating elements 30 are inserted into the corresponding receptacle 32 and surrounded on both sides by the sheet metal bands 34, 36. Thereafter the recesses are plastically deformed inwards, comprehensively forming the printed conductors 34, 36.

The heat generating element 10 is formed as a preassembled component and can thus be handled during assembly without the risk that the printed conductors 34, 36 or even the PTC heating elements 30 inserted in the positional frame 28 will be lost. It must however be pointed out that normally the retaining ridges only fix the sheet metal bands 34, 36 in the positional frame, but do not contact them with contact pressure against the PTC heating elements 30, which is sufficient to reliably power the PTC heating elements 30 in operation. With the embodiment discussed within the scope of the present invention, this is in any case caused by a spring element which is inserted into the housing 2 and puts the complete layer structure consisting of the heat generating elements 10 and the heat dissipating elements 12 under tension.

As can be seen, in particular from FIGS. 3 and 6, a sheet metal band, i.e. the sheet metal band 34 illustrated in FIG. 6, is bent out of the plane of the heat generating element 10. Consequently, an offset 42 is produced between the plane in which the sheet metal band 34 contacts the PTC heating elements 30 and a free end 44 which extends parallel to the first mentioned principal section of the sheet metal band 34 due to being again bent, but in the opposite direction. As can be seen from FIG. 3, this free end 44 is mechanically and electrically connected by a crimping element 46 to the assigned contact lug 14.

The upper heat dissipating elements in FIG. 3 designated with reference numerals 10.3 and 10.4 have an offset 42.3 and 42.4 projecting from the upper sheet metal band 34. The lower heat generating element 10.1 has an offset 42.1 projecting downwards. The sheet metal bands 34, 36 of the heat generating elements 10 designated with reference numeral 10.2 are bent on both sides to form an offset 42.20 or 42.21 and each is provided with a contact lug 14. Due to these differences there is the possibility of preventing interchanging the positions of the heat generating elements 10.3 and 10.2 within the housing 2. In this case due to the design of the contact lug receptacles 48, the embodiment permits interchanging of the two central heat generating elements 10.2 and 10.3. An appropriate interchangeability is also given for both outer heat generating elements 10.1 and 10.4.

The slots 15 previously mentioned with reference to FIG. 1 extend from the outer side of the housing 2 and run into the respectively widened spring receptacles 48 opposite the slots 15. Behind this spring receptacle 48 a constricted slot 50 is in turn formed, which accommodates a sheet metal piece 120 shaped by punching to form the contact lug 14 as well as the free end 44 of the assigned sheet metal band 34.

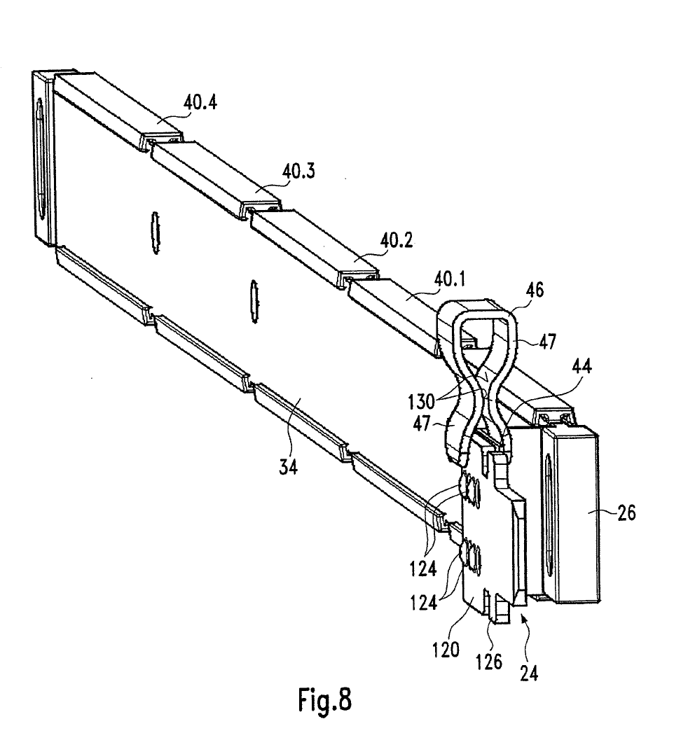

FIG. 8 illustrates the connection between a heat dissipating element 10 and the sheet metal piece 120. In this respect a spring clamp 46 is provided, the oppositely situated spring limbs 47 of which clamp the sheet metal piece 120 and the free end 44 of the sheet metal band 34 between them. In this respect the free end of the sheet metal band 34 and the sheet metal piece 120 each have an overlapping longitudinal part 122 in which the two elements 120, 44 are located parallel and adjacent to one another. Here with the illustrated embodiment protrusions 124 are formed on the sheet metal piece 120 in the overlapping longitudinal part 122 through which the sole electrical contacting occurs between the free end 44 and the sheet metal piece 120. The flat region of the sheet metal piece 120 in the overlapping longitudinal part 122 is thus provided extending parallel at a distance to the free end 44 of the sheet metal band 34.

As can be seen particularly in FIGS. 11 and 12, the sheet metal piece 120 has two rows of protrusions 124 extending parallel to one another. By stamping, these protrusions 124 are formed on both sides of the sheet metal piece 120 such that the sheet metal piece can contact the sheet metal band 34 at its free end 44 in any direction without the desired defined electrical contact between the two elements 34, 120 being lost. Oppositely situated grooves 126 are recessed between the overlapping longitudinal part 122 and a plug-on section 140, which is formed by the front end of the sheet metal piece 120 which protrudes beyond the housing 2.

On the front plug-on section 140 the sheet metal piece 120 terminates conically to facilitate the plugging on of a female plug element, which is not illustrated, onto the contact lug 14. As FIG. 11 illustrates, the overlapping longitudinal part 122 has a greater width than the plug-on section 140. This greater width initially continues behind the groove 126 so that a defined limit stop 142 for the plug element is formed by the sheet metal piece 120.

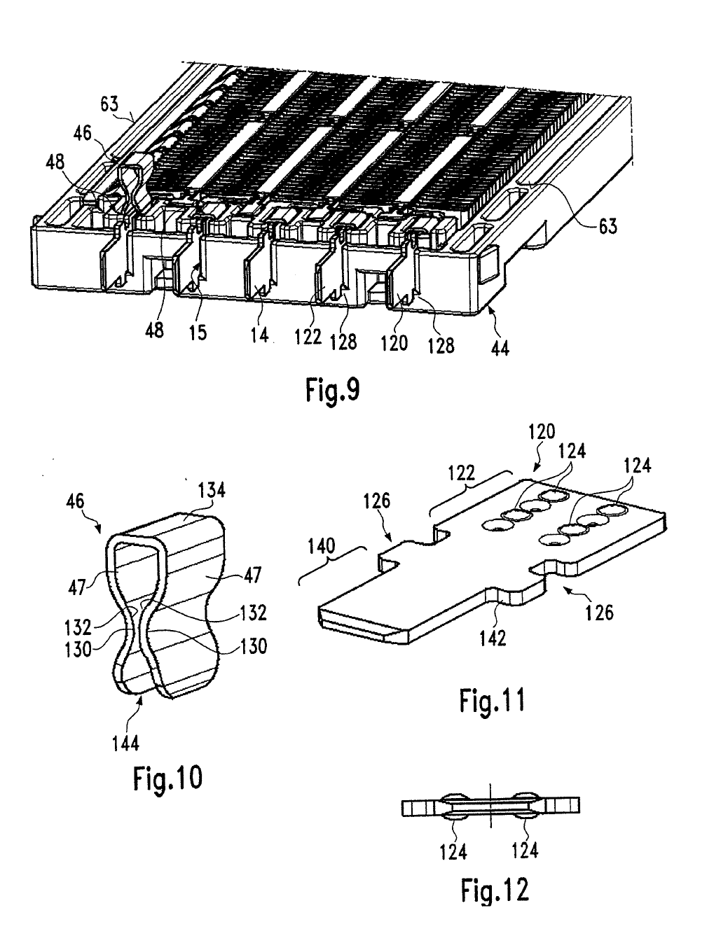

The spring element illustrated in detail in FIG. 10 in the form of a spring clamp 46 has the two already mentioned spring limbs 47, which are joined together via a ridge 134. The spring limbs 47 have curved protrusions 130 which form oppositely situated convex contact bases 132. Via these contact bases 132 the spring clamp 46 interacts with the free ends 44 of the sheet metal band 34 and the sheet metal piece 120 in an installation position. To achieve the installation position the spring clamp 46 is brought into the position shown in FIG. 8 and pushed into the housing lower part illustrated in FIG. 9 in the insertion direction of the layer structure. This insertion direction extends parallel to the planes given by the positions of the layer structure. Here, an insertion opening 144 with a large opening cross-section initially accommodates the two parts 134, 120. With the progressive insertion movement the convex contact bases 142 slide on the sheet metal piece 120 at one side and at the other side on the free end 44 of the sheet metal band 34 with the spring clamp 46 opening out. The convex contact bases finally pass the first row of protrusions 124 and spring between the two rows of protrusions 124. This insertion movement in each case terminates when the inner surface of the ridge 134 abuts the face side of the sheet metal piece 122 or the sheet metal band 34.

The previously described assembly occurs once the layer structure consisting of the heat generating elements 10 and heat dissipating elements 12 has been inserted into the housing lower part 4 (cf. FIG. 9). Thereafter the free ends of the selected sheet metal bands 34, which provide contacting of the heating block in the housing 2, lie free within the spring receptacles 48. Here, the free ends 44 penetrate the slot 50, but terminate before the slot 15. In the insertion direction of the layer structure the sheet metal pieces 120 are now brought into the respective slots 15, and in fact such that a protrusion 128 formed on the circumferential edge of the housing lower part engages the groove 126. This position is illustrated in FIG. 9. The sheet metal piece 120 introduced into the housing lower part 4 extends in the longitudinal extension, i.e. in the extended direction of the layers of the layer structure into the rear slot 50 and penetrates the front slot 15, as can be seen from FIG. 3. Then the spring clamp 46 is pushed into the spring receptacle 48 from above. As can be seen, particularly from FIG. 3, the housing lower part 4 is formed such that the spring clamp 46 is fixed with only slight play in the spring receptacle 48.

As can be seen from FIG. 5, the housing upper part 6 has a recess 36 at the height of the slots 15, which can accommodate the free end of a spring receptacle 48. This definitive embodiment of the housing upper part 6 is due to the fact that the spring receptacle 48 protrudes beyond an edge surrounding the layer structure, which for example contains the inner surface 63 of the longitudinal spars. In the extended direction of the layers of the layer structure the recess 36 of the housing upper part 6 continues through a constricted recess 138, which however does not extend up to the frame opening 16 of the housing upper part. The upright sheet metal piece 120 fits into this constricted recess with its face side. The closed end of the constricted recess 138 forms a limit stop for the sheet metal piece 120.

With the previously illustrated embodiment the electrical contacting between the sheet metal piece 120 and the sheet metal band 34 occurs solely through the clamping force of the spring clamp 46. This is formed by spring steel and causes a compressive pressure of between 1000 and 1500 N/mm² between the sheet metal piece 120 and the sheet metal band 34. With a relaxed spring clamp 46 the smallest distance of the convex contact bases 132 is at maximum 40% of the accumulated thickness of the sheet metal piece 120 and the sheet metal band 34.

The sheet metal piece 120 is formed from a material which is a good electrical conductor, for example a copper/tin alloy. At least the plug-on section 140, preferably the complete sheet metal piece 120, are each provided with a silver coating on the oppositely situated side surfaces in order to achieve the best possible contact on one hand between the sheet metal piece 120 and the sheet metal band 34 and on the other hand between the contact lug 14 and the plug element which is to be plugged on it.

1. An auxiliary heater for a motor vehicle, comprising:
a layer structure comprising
a heat generating element with at least one PTC heating element and printed conductors contacting the PTC heating element on both sides thereof for powering the PTC heating element and,
at least one heat dissipating element connected for thermal conduction with the heat generating element, and
a housing accommodating the layer structure as well as contact lugs for the connection of the auxiliary heater to a power source,
wherein
the contact lugs are formed by stamped sheet metal pieces which are electrically connected to selected printed conductors.

2. The electrical auxiliary heater according to claim 1, wherein at least some of the printed conductors are, in each case, formed by sheet metal bands, and wherein the stamped sheet metal pieces and the sheet metal bands have an overlapping longitudinal part at which each stamped sheet metal piece contacts an assigned sheet metal band.

3. The electrical auxiliary heater according to claim 2, wherein, in the overlapping longitudinal part, at least one protrusion is provided on at least one of the sheet metal piece and on the printed conductor, via which generally the electrical contacting between the printed conductor and the contact lug at least takes place.

4. The electrical auxiliary heater according to claim 2, wherein the printed conductor is connected to the contact lug by a spring element.

5. The electrical auxiliary heater according to claim 4, wherein the spring element holds the sheet metal piece on the housing.

6. The electrical auxiliary heater according to claim 4, wherein the housing forms a spring receptacle in which the spring element is held with only slight play.

7. The electrical auxiliary heater according to claim 4, wherein the housing comprises a housing lower part at least partially circumferentially containing the layer structure and a housing upper part which can be joined to the housing lower part, and
wherein the housing lower part and the spring element are formed such that an installation position of the spring element, in the longitudinal direction of the printed conductors, is essentially provided by the interaction of the housing lower part and the spring element.

8. The electrical auxiliary heater according to claim 2, wherein the spring element is formed in the shape of a spring clamp, oppositely situated limbs of which clamp, in an installation position, between them the printed conductor and the sheet metal piece.

9. The electrical auxiliary heater according to claim 8, wherein protrusions are formed on both sides of the sheet metal piece and the printed conductor, and wherein at least one of the spring limbs contacts between at least two protrusions of the sheet metal piece or the printed conductor.

10. The electrical auxiliary heater according to claim 6, wherein the housing lower part forms the spring receptacle which opens in the insertion direction of the layers of the layer structure and in which the overlapping longitudinal part is located.

11. The electrical auxiliary heater according to claim 6, wherein the spring receptacles have, in the longitudinal direction of the layers of the layer structure, opening slots, which are suitably formed for the accommodation of at least one of the sheet metal piece and the printed conductor.

12. The electrical auxiliary heater according to claim 11, wherein the maximum penetration depth of the sheet metal piece into the housing is limited due to the design of at least one of the slots.

13. The electrical auxiliary heater according to claim 7, wherein each sheet metal piece forms a plug-on section at an end thereof which protrudes beyond the housing, and wherein each plug-on section has specially adapted functional surfaces for cooperating with connecting surfaces of a plug element.

14. The electrical heating device according to claim 13, wherein the sheet metal piece has, between a plug-on section for plugging on the plug element and its overlapping longitudinal part, at least one groove opening out at a side thereof, and wherein a protrusion formed by the housing engages the groove.

15. The electrical heating device according to claim 14, wherein the overlapping longitudinal part of the printed conductor terminates in front of the groove.

16. The electrical heating device according to claim 14, wherein the protrusion is formed as part of an edge running circumferentially around the housing.

17. The electrical auxiliary heater according to claim 6, wherein the spring receptacles for a number of contact lugs protrude beyond an edge of the housing lower part which delimits an edge of the housing running circumferentially around the housing.

18. Electrical auxiliary heater according to claim 6, wherein the upper side of the layer structure terminates at about the same height as free ends of the spring receptacles.
